(19) United States
(12) Patent Application Publication
(10) Pub. No.: US 2013/0074068 A1
(43) Pub. Date: Mar. 21, 2013

(54) Method, System, and Computer Program for Implementing a Customizable Virtual Appliance

(71) Applicants: Giuseppe Ciano, Rome (IT); Rossella De Gaetano, Rome (IT); Antonio Di Cocco, Rome (IT); Luigi Pichetti, Rome (IT)

(72) Inventors: Giuseppe Ciano, Rome (IT); Rossella De Gaetano, Rome (IT); Antonio Di Cocco, Rome (IT); Luigi Pichetti, Rome (IT)

(73) Assignee: International Business Machines Corporation, Armonk, NY (US)

(21) Appl. No.: 13/617,696

(22) Filed: Sep. 14, 2012

(30) Foreign Application Priority Data
Sep. 16, 2011 (IT) MI2011A001667

(51) Int. Cl. G06F 9/455

(52) U.S. Cl. 718/1

(57) ABSTRACT

A method for managing a virtual image in a cloud environment by implementing a customizable virtual image deployment may be provided. The method may comprise generating a virtual image and a set of configuration parameters related to specific parts of the virtual image, and assigning a set of values to the configuration parameters. Furthermore, the method may comprise deploying the virtual image using the set of values assigned to the parameters, such that parts of the virtual image may be deployed as a customized virtual image depending on the set of values of the parameters.

### BACKGROUND

Embodiments relates generally to a method of managing a virtual image in a cloud environment. The invention relates further to a virtual image managing system, a computer system, a data processing program, and a computer program product.

Today, more and more computing services are delivered in the form of computing as a service rather than a product, whereby shared resources, software and information are provided to computers and other devices as a utility over a network, typically the Internet. This so-called cloud computing may be deployed as public cloud services, private cloud services or a hybrid form. Many cloud computing environments use standardized hardware platforms running a hypervisor for abstracting hardware specific elements. On top of a hypervisor, one or more virtual machines may be deployed. An operating system as well as infrastructure software and end user applications run on these virtual machines.

In order to better manage these cloud computing environments, system administrators may generate quasi-standardized virtual images of virtual machines that may comprise an operating system and a series of applications.

In order to be suitable to different requirements—meaning they may be deployed for different purposes—like e.g., a web server, a database server or an application server—these virtual images may become rather large. They may comprise a series of applications in order to be used for different deployments. However, not in all deployment cases will all different applications or application components be required for a specific deployment of the complete virtual image for a specific task.

One idea of adapting a virtual image to more specific requirements is based on patching a virtual image after the creation. Document US 2011/0078680 A1 discloses a system and method that may be used to reconfigure a virtual server image suitable for a cloud deployment. In accordance with one embodiment, the system and method comprises providing a virtual server image, which can be executed on one or a plurality of hypervisors, and which provides a virtual machine environment for a software application, wherein the virtual server image contains a bootable part of the virtual machine, a non-bootable part of the virtual machine, software application code for the software application, and a software application data for the software application. The method comprises further providing software application data for the software application and receiving a virtual server image patch. Furthermore, information in the virtual server image patch is used to reconfigure the contents of the virtual server image from its original content to a reconfigured content. This is done to create a reconfigured virtual server image.

The core idea here is to adapt a virtual server image to be deployable on different types of hypervisors. Moreover, patching a virtual server image is a rather complex process. The term patching is being used in computer technologies for a couple of decades and is related to bug fixing in existing compiled software code.

A common usage of virtual images is to have an image which may be deployed several times generating new virtual systems which then always behave in the same way. A typical example may be the usage and test environments, which may allow re-creating the same environment different times with always the same results.

The above scenario may work nicely in a case where all the software components of the solution may fit into a single virtual image, which may be easily deployed and instantiated. Also, the virtual image may be self-contained.

However, this is neither always possible nor desirable for complex scenarios: A resulting single virtual image may require a considerable high disk footprint. High disk footprints (in the range of e.g., 100 GB range) may have associated storage deployment delays and associated costs. If the resulting virtual machine is also too resource consumptive—e.g., requiring a large number of concurrent processes or physical memory—a hypervisor may not be able to assign enough parallel resources—e.g., number of virtual CPUs may be limited—hence causing scaling and performance issues.

For this reason, when on one hand the software solution—i.e., the virtual image—to be deployed may become too complex, and on the other hand it may be desirable to get benefits of virtualization without introducing performance bottlenecks, there may be a requirement for a more flexible way of deploying a virtual image without making compromises regarding the manageability of a standardized virtual image template.

### BRIEF SUMMARY

This need may be addressed by a method for managing a virtual image in a cloud environment, a virtual image managing system, a computer system, a data processing program, and a computer program product according to the independent claims.

In one embodiment, a method for managing a virtual image in a cloud environment by implementing a customizable virtual image deployment may be provided. The method may comprise generating a virtual image and a set of configuration parameters related to specific parts of the virtual image, and assigning a set of values to the configuration parameters. Furthermore, the method may comprise deploying the virtual image using the set of values assigned to the parameters, such that parts of the virtual image may be deployed as a customized virtual image depending on the set of values of the parameters.

In another embodiment, a virtual image managing system for managing a virtual image in a cloud environment may be provided. The virtual image managing system may comprise a first generation unit adapted to generate a virtual image, a second generation unit adapted to generate a set of configuration parameters related to specific parts of the virtual image, an assignment unit adapted to assign a set of values to the configuration parameters, and a deployment unit adapted to deploy the virtual image using the set of values assigned to the configuration parameters, such that parts of the virtual image are deployed as a customized virtual image depending on the set of values of the configuration parameters.

It may be noted that the virtual image may be a software appliance comprising a virtual machine environment running an operating system and one or more software applications.

It may be understood that during generation time a flexible virtual image or virtual image template may be created and not an unchangeable virtual image. Instead it may be a virtual image that may be adapted at deployment time. In addition to regular components of a virtual image, activation logic may be included into the virtual image. Values of the configuration parameters may influence the activation logic at deployment time of the virtual image. Such influence may cause an activation of only parts—or all parts—of the virtual image potentially resulting in a smaller virtual image actually to be deployed. Unused parts may not be activated at all. Parts that may not be activated may no longer be part of the virtual image. Thus, a reconfigurable, customizable virtual image may be the result of the method.

In the context of this application, the following conventions have been followed:

Virtual image—a virtual image may denote a complete computing environment to be bootable on top of a hypervisor, alternatively several hypervisors. It may comprise a virtual machine, i.e., an operating system with a series of applications. In a reconfigurable form, it may be named a virtual appliance, a virtual software appliance or simply a soft appliance.

Virtual machine—A virtual machine may denote a software implementation of a computer (i.e. a computer) that executes programs like a physical machine. Several virtual machines may run on one physical machine. A hypervisor may be an instruction layer between the physical machine and the plurality of virtual machines.

Generating a virtual image may denote a process of defining components that comprise a virtual image. The result of the process may be a large binary file comprising an operating system and one or more applications. Examples of applications may be a web server, a database server, or a transaction program. The generated virtual image may represent a bootable image.

The term “assigning a set of values” may denote a process of defining specific values for specific parameters. The parameters may be configuration parameters. The result of the assigning process may be a list of values in a configuration parameter list. Typically, the “assigning a set of values” may be performed at deployment time of a virtual image but is not limited to this time.

The term “deploying a virtual image” may denote a process of generating a specific instance of a pre-existing virtual image or virtual image template to be executed on top of a hypervisor. There may be a plurality of instantiations of a virtual image template on one or more physical machines on one or more hypervisors.

Points of variability—The term points of variability may denote areas in the virtual image that may be split. One part may continue to be a bootable image whereas the other part may not be used. Such parts may be complete applications or application components. Also, parts of the operating system or the infrastructure software may be such parts.

Activation logic—The term activation logic may denote a non-traditional component of a virtual image that may be required as part of this invention. It may work together with the configuration parameters—i.e., the points of variability—in order to make the virtual image template flexible at deployment time.

Hypervisor—The term “hypervisor” may denote a virtual machine manager that may allow multiple operating systems to run concurrently on a host computer or physical machine. The hypervisor may manage an execution of guest operating systems in combination with associated applications. Thus, multiple instances of a variety of operating systems and applications may share virtualized hardware resources.

The above-described method for managing a virtual image in a cloud environment may offer a couple of advantages.

Basically, a multi-image virtual client, which may be deployed with more inherent flexibility, may be creatable. It may no longer be required to keep a library of individual, only slightly different virtual images and manage versioning and compatibility of all variations of one virtual image template. Only a single virtual image or single virtual image template may be needed and managed. The created single virtual image may behave differently based on a set of configuration parameters used at deployment time. The configuration parameters may be definable or editable during or before an actual deployment occurs. The single virtual image will be flexible and adaptable to deployment capabilities it has been built for. The flexibility may e.g., be expressed at deployment time in terms of scale. E.g., one instance may comply with a topology suited for 100 nodes, another one for 1000 nodes, and again another one for 10000 nodes. In this context, a node may specify any computing resource required. Or, the flexibility may be expressed in terms of functional requirements. E.g., an instance may be deployed in a topology supporting a high-availability configuration in contrast to normal availability requirements.

Despite its dynamic capabilities, the virtual image may be a single image with a capacity to be cloned logically by a setup launch-pad that may connect cloned instances to a hypervisor. In each of the cloned instances, different activated or deactivated—i.e., de-installed—run-time components may be present. They all may have been included in the original virtual image template.

One option may be to de-install the components after the deployment. Another way may be to not deploy/clone at all the software components that may not be needed based on the role assigned in the deployment.

Thus, a single virtual image may be deployed in different roles and/or different topologies. If, for example, a virtual image template may comprise applications like, e.g., a web server, a database, and a transaction system, then one role may be the role of a web server. Another role may be a database server or a server supporting transactions. In OVF terms, a person skilled in the art may code it as, e.g., type=high-scale, type=compact, type=POC (POC=Proof of Concept, i.e., test system).

In one embodiment of the method, the generating of the virtual image may comprise defining points of variability of the virtual image. The points of variability may be abstract points at which the virtual image may be separated into at least two parts. The points of variability may be used as a measure to define which parts of a complete virtual image template may be separated. A definition of these points of variability may be used at a later stage during a life-cycle of the virtual image. Information related to points of variability may be used by an activation logic to decide which parts of the virtual image may actually be deployed, and which parts may be separated from the newly instantiated virtual image.

In another embodiment of the method, the generating of the virtual image may comprise to include activation logic into the virtual image, in particular at generation time of the virtual image. Such activation logic may be used at a later stage, e.g., at deployment time, to define which parts of the virtual image may have to be activated and which parts may not have to be activated. As a result, an activated virtual image, i.e., a deployed virtual image, may be smaller in physical size, i.e., number of bytes, because of not activated parts of the virtual image template. As discussed above already, one option may be to de-install the components after the deployment. Another way may be to not deploy/clone at all the software components that may not be needed based on the role assigned in the deployment.

In again another embodiment of the method, the activation logic may be adapted to activate the parts of the virtual image depending on the points of variability and the set of values of the configuration parameters. As discussed above, values for the configuration parameters may be defined just before or as part of a deployment process of a virtual image. Therefore, combining the information related to the points of variability and the set of values of the configuration parameters may be used by a virtual image adaptive developer. Such a virtual image active developer may be used by a cloud administrator, i.e., a person administrating a cloud computing environment to deploy an instance of a virtual image.

With the help of the virtual image adaptive developer, the information related to the points of variability and the set of values of configuration parameters, a final image of the virtual image may be defined. The virtual image adaptive developer may be implemented as a graphical launch-pad for the virtual image or as a plug-in to an existing virtual center manager, allowing virtual images to be deployed on hypervisors.

In another embodiment of the method, the generating of the configuration parameters may comprise storing the configuration parameters together with the virtual image. The storing of the configuration parameters may be performed in a listed form. The list may be named virtual image deployment descriptor. It may be noted that this virtual image deployment descriptor may depend on the content of the virtual image, i.e., the individual components of the virtual image, and the defined points of variability. Just before or at deployment time of the virtual image, the virtual image deployment descriptor may be displayed in form of a graphical representation such that values may be assigned to individual parts using the virtual image deployment descriptor or simply to individual configuration parameters.

In yet another embodiment of the method, the generating of the virtual image and the set of configuration parameters may be based on using a virtual image template developer. Such virtual image template developer may be a graphical development tool to be used by a programmer or administrator when defining a virtual image template, its further software components, and its points of variability. The components may comprise an operating system and one or more software applications running on top of the operating system.

In another embodiment of the method, the generating of the virtual image may comprise a generation of the virtual image in a standardized format. One example of this standardized format may be the Open Virtualization Format as defined by the Distributed Management Task Force, Inc. (DMTF).

In another embodiment of the method, the deploying of the virtual image may comprise a deploying in different topologies. Topologies may be “smallest footprint”, “highest availability”, etc. It may be coded as type=high-scale, type=compact, type=POC or others.

Furthermore, a computer or computer system may comprise the virtual image managing system, as described above, and referring to the method for managing a virtual image in a cloud environment.

It should be noted that embodiments may take the form of an entire hardware implementation, an entire software embodiment or an embodiment containing both, hardware and software elements. In a preferred embodiment, the invention is implemented in software, which includes, but is not limited to, firmware, resident software and microcode.

In another embodiment, a data processing program for execution in a data processing system is provided comprising software code portions for performing the method, as described above, when the program is run on a data processing system. The data processing system may be a computer or computer system.

Furthermore, embodiments may take the form of a computer program product, accessible from a computer-usable or computer-readable medium providing program code for use, by or in connection with a computer or any instruction execution system. For the purpose of this description, a computer-usable or computer-readable storage medium may be any apparatus that may contain means for storing, communicating or transporting the program for use, by or in a connection with the instruction execution system, apparatus, or device. A computer-readable signal medium, on the other hand, may be any means for propagating the program for use, by or in a connection with the instruction execution system, apparatus, or device.

The medium may be an electronic, magnetic, optical, electromagnetic, infrared or a semi-conductor system for a propagation medium. Examples of a computer-readable storage medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

Particularly, an embodiment provides a data processing program for execution in a data processing system comprising software code portions for performing the claimed method when said program is run on a data processing system. Moreover, an embodiment provides a computer program product stored on a computer usable medium, comprising computer readable program means for causing a computer to perform the same method when said program is run on the computer.

It should also be noted that embodiments of the invention have been described with reference to different subject-matters. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

### BRIEF DESCRIPTION OF THE DRAWINGS

Preferred embodiments of the invention will now be described, by way of example only and with reference to the following drawings:

FIG. 1 shows a block diagram of an embodiment of the method for managing a virtual image in a cloud environment;

FIG. 2 illustrates a block diagram of a flow-chart for of an embodiment of the method, in particular, for defining/creating a virtual image;

FIG. 3 illustrates a block diagram of a flow-chart for an embodiment of the method, in particular, for a deployment of the virtual image;

FIG. 4 shows a block diagram of how a virtual image template may be instantiated in a plurality of virtual sub-images;

FIG. 5 shows a block diagram of an embodiment of the virtual image managing system;

FIG. 6 illustrates points of variability within a virtual image in context of an embodiment;

FIG. 7 shows a block diagram of an embodiment of a computer system including the inventive virtual image managing system; and

FIG. 8 shows a block diagram of an embodiment of a virtual machine environment.

### DETAILED DESCRIPTION OF EMBODIMENTS OF THE INVENTION

In the following, a detailed description of the figures will be provided. All illustrations in the figures are schematic. Firstly, a block diagram of an embodiment of the method for managing a virtual image will be described. Afterwards, embodiments of the method and a virtual image managing system will be described.

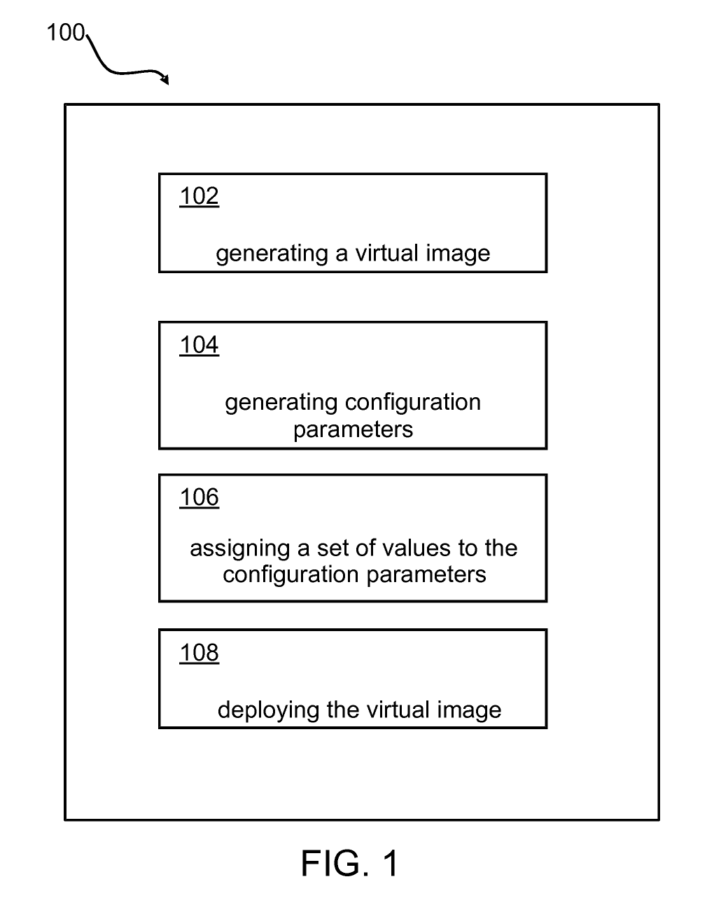

FIG. 1 shows a block diagram of an embodiment of a method 100 for managing a virtual image in a cloud environment. The method may comprise generating, 102, a virtual image, and generating, 104, a set of configuration parameters related to specific parts of the virtual image. Furthermore, the method may comprise assigning, 106, a set of values to the configuration parameters, as well as deploying, 108, the virtual image using the set of values assigned to the configuration parameters such that parts of the virtual image are deployed as a customized virtual image depending on the set of values of the configuration parameters.

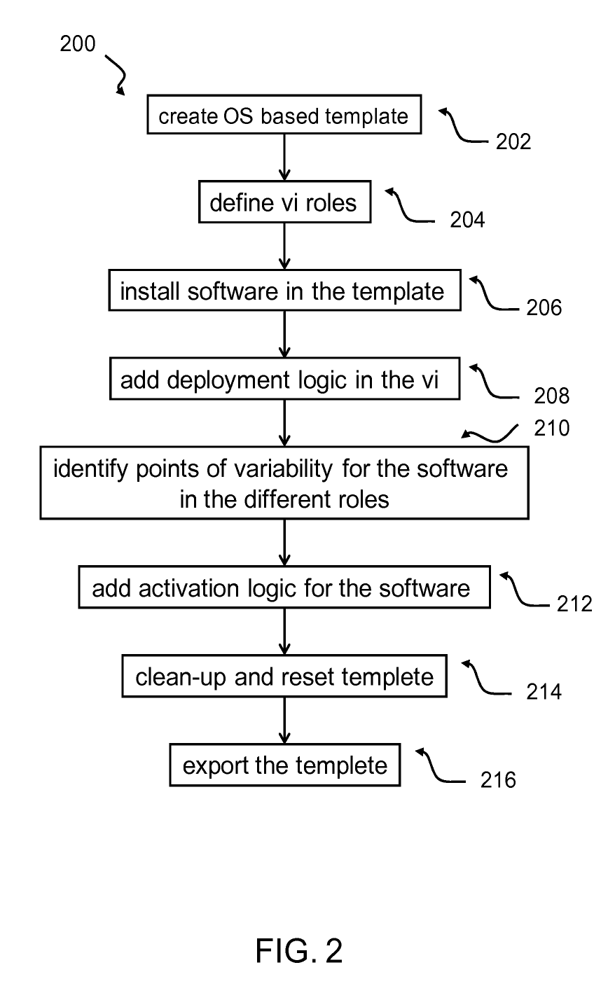

FIG. 2 may illustrate a block diagram of an embodiment of a flow-chart 200 for defining/creating a virtual image. Firstly, an operating system base template may be created, 202. Secondly, different behaviors of the base template may be defined for different virtual image roles so that the virtual image may support different deployment types, step 204. Deployment types may be defined by the smallest possible footprint of the virtual image or, e.g., high availability or other parameters. Next, application or infrastructure software may be installed in the virtual image in order to provide a basis for different virtual image roles, 206. As a next step 208, additional deployment logic may be added to the virtual image to make it bootable in order to later on instantiate the image. Only those software parts that may support the virtual image role may be activated later on.

As a next step, it may be required to identify points of variability that may be supported for the software (infrastructure or application software) available for the different virtual image roles, step 210. In addition to identifying or defining the points of variability, related configuration parameters may be defined. However, it may also be possible to generate the configuration parameters out of the defined points of variability that may be included in coded form into the virtual image. Furthermore, in a next step 212, additional activation logic may be added to the virtual image to allow a reconfiguration of the software available for the different virtual image roles. Two final steps may be performed in order to finish the virtual image template creation: a clean-up and reset of the virtual image template, 214, and an export of the created virtual image template, 216.

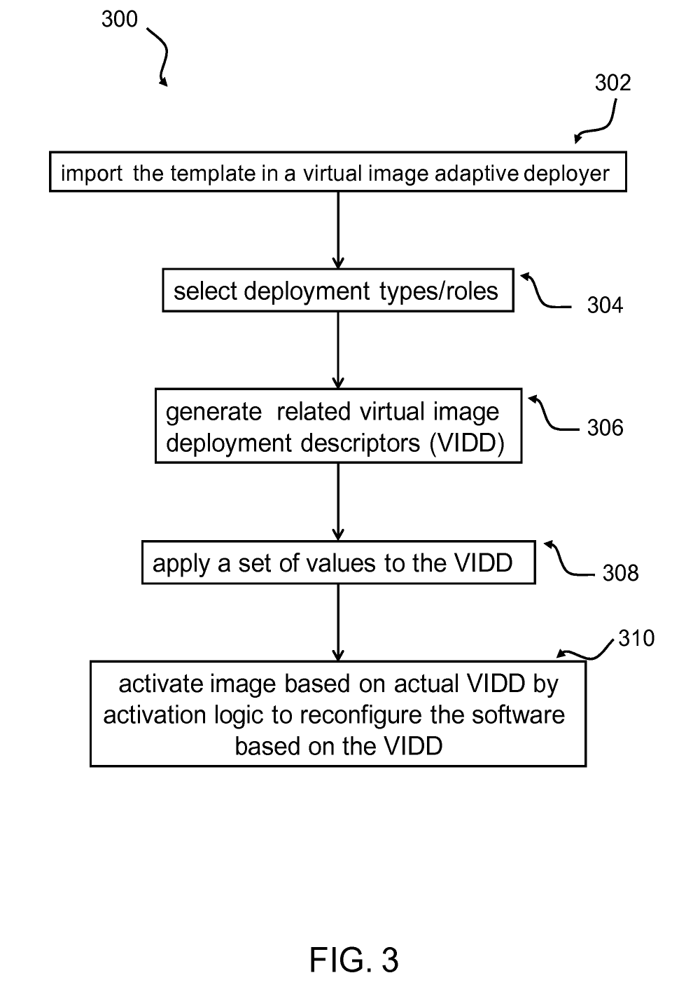

FIG. 3 may illustrate a block diagram of an embodiment of a flow-chart 300 for a deployment of the virtual image. The formerly exported virtual image template may now be imported, 302, in a virtual image adaptive developer. The imported virtual image template may have been stored in a standardized form, for example in an OVF form (Open Virtualization Format). Next, 304, specific deployment types and/or roles for the virtual image template may be selected. Based on this, the virtual image adaptive developer may generate, 306, proper configuration parameters or virtual image deployment descriptors. In step 308, the configuration parameters or the content of the virtual image deployment descriptor may interactively be customized such that the activation logic, together with the information related to the points of variability, may be used to reconfigure the virtual image template. In step 310, the selected and specified parts of the virtual image may be activated such that the virtual image is finally customized for deployment. In this step, the application logic plays an ample role because it finally enables the correct activation of those parts of the virtual image template that have been selected according to a specified role or type for the virtual image.

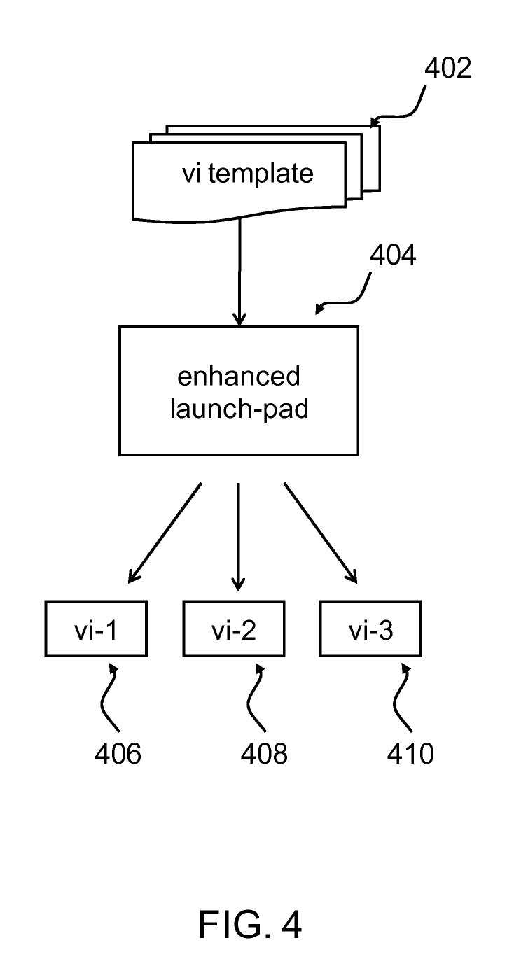

In FIG. 4 shows a block diagram of how a virtual image template may be instantiated in a plurality of virtual sub-images. A virtual image template 402 may be stored in a virtual image template library (not shown) for easy management of virtual image templates. This virtual image template may have been created during the virtual image template creation process. At deployment time, an enhanced launch-pad 404 may be used to perform the process “virtual image template deployment” as described in the context of FIG. 3. As a result, starting from one virtual image template, different virtual images 406, 408, 410 may be deployed. Virtual image 1, 406, may for example have a host name A.X.Y.Z running a database application and an LDAP directory. Virtual image 2, 408, may have a host name B.X.Y.Z running as application, a web application server, and an http-server. A third virtual image, virtual image 3, 410, may have as host name the name C.X.Y.Z running a web application service node agent and a first web application. Another virtual image (not shown) may have the host name C.X.Y.Z running again a web application service node agent together with a second web application.

This may show that starting from one virtual image template 402, different roles for virtual images may be generated to run in a cloud environment as virtual machines. It may be noted that the process “virtual image template deployment” may be completely different to a patching of an existing virtual template. One of the key differentiations is that the virtual image template created in the process “virtual image template creation” may have a related set of configuration parameters as well as an activation logic and defined points of variability. All of these components may be used during the process “virtual image template deployment”. Also, at deployment time, the configuration parameters may be generated based on the virtual image with its points of variability.

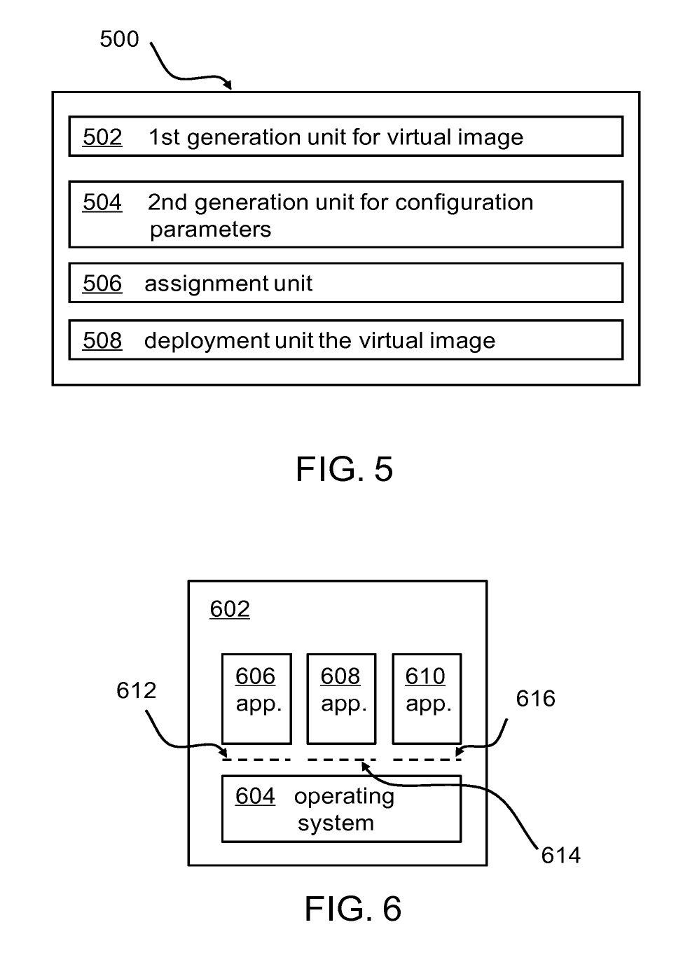

FIG. 5 shows a virtual image managing system 500 for managing a virtual image in a cloud environment by implementing a customizable virtual image deployment. The virtual image managing system 500 may comprise: a first generation unit 502 adapted to generate a virtual image, and a second generation unit 504 adapted to generate a set of configuration parameters related to specific parts of the virtual image; an assignment unit 506 adapted to assign a set of values to the configuration parameters, and a deployment unit 508 adapted to deploy the virtual image using the set of values assigned to the configuration parameters, such that parts of the virtual image are deployed as a customized virtual image depending on the set of values of the configuration parameters.

FIG. 6 may illustrate point of variability within a virtual image. Reference numeral 602 may represent a complete virtual image. It may comprise an operating system 604 and, in this example, three applications 606, 608 and 610. Reference numerals 612, 614 and 616 may refer to points of variability in a very abstract form. These dashed lines 612, 614, 616 may symbolize areas at which the virtual image template 602 may be broken. Thus, if the point of variability 616 may be applied, application 610 may not be part of a deployed instance of the virtual image 602. Only application components 606 and 608 as well as the operating system 604 may then be part of a deployed instance of the virtual image 602.

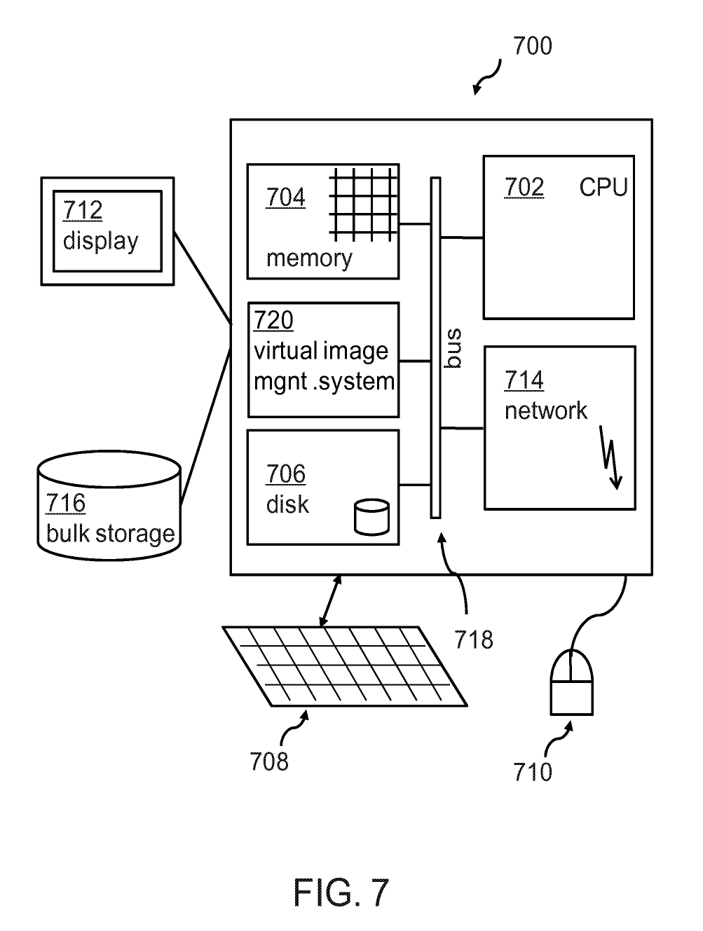

Embodiments of the invention may be implemented on virtually any type of computer, regardless of the platform being suitable for storing and/or executing program code. For example, as shown in FIG. 7, a computer system 700 may include one or more processor(s) 702 with one or more cores per processor, associated memory elements 704, an internal storage device 706 (e.g., a hard disk, an optical drive such as a compact disk drive or digital video disk (DVD) drive, a flash memory stick, etc.), and numerous other elements and functionalities, typical of today's computers (not shown). The memory elements 704 may include a main memory, e.g., a random access memory (RAM), employed during actual execution of the program code, and a cache memory, which provides temporary storage of at least some program code and/or data in order to reduce the number of times, code and/or data must be retrieved from a long term storage medium or external bulk storage 716 for an execution. Elements inside the computer 700 may be linked together by means of a bus system 718 with corresponding adapters. Additionally, the virtual image management system 720—which may be equivalent to FIG. 5, 500—may be attached to the bus system 718.

The computer system 700 may also include input means, such as a keyboard 708, a pointing device such as a mouse 710, or a microphone (not shown). Furthermore, the computer 700, may include output means, such as a monitor or screen 712 (e.g., a liquid crystal display (LCD), a plasma display, a light emitting diode display (LED), or cathode ray tube (CRT) monitor). The computer system 700 may be connected to a network (e.g., a local area network (LAN), a wide area network (WAN), such as the Internet or any other similar type of network, including wireless networks via a network interface connection 714. This may allow a coupling to other computer systems or a storage network or a tape drive. Those, skilled in the art will appreciate that many different types of computer systems exist, and the aforementioned input and output means may take other forms. Generally speaking, the computer system 700 may include at least the minimal processing, input and/or output means, necessary to practice embodiments of the invention.

Further, those skilled in the art will appreciate that one or more elements of the aforementioned computer system 700 may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources or a smart phone.

Further, software instructions to perform embodiments of the invention may be stored on a computer readable medium, such as a compact disk (CD), a diskette, a tape, or any other computer readable storage device.

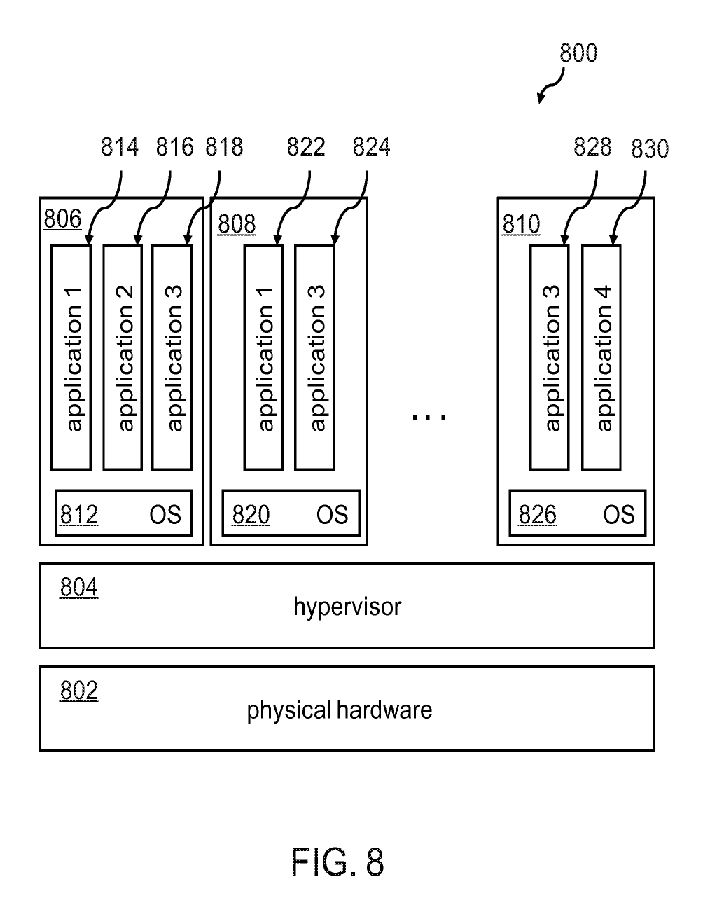

FIG. 8 shows a block diagram 800 of an embodiment of a virtual machine environment according to the state of the art. On top of the physical hardware 802, a hypervisor 804 is schematically illustrated. The hypervisor 804 may be a basis for running a series of virtual images or virtual machines 806, 808, 810. E.g., virtual machine 806 may comprise an operating system 812 and three applications 814, 816, 818. A second virtual machine 808 may comprise the operating system 820 and two applications 822 and 824. Finally, virtual machine 810 may comprise an operating system 826 and two applications 828 and 830. There may be no limitations regarding the different applications 814, 816, 818, 822, 824, 828, 830. They all may be infrastructures components like web servers or databases or network systems as well as classical end user applications like customer relation management systems and enterprise resource management systems or any other end-user-oriented application with direct screen access or running on a web browser. However, it should be mentioned that—in contrast to the inventive method described above—all different virtual machines 806, 808, 810 have to be managed separately according to the state of the art. There may be no common virtual image template to be managed. Every image may need a special and separate treatment without the inventive concept described in this document.

While the invention has been described with respect to a limited number of embodiments, those skilled in the art, having benefit of this disclosure, will appreciate that other embodiments can be devised, which do not depart from the scope of the invention as disclosed herein. Accordingly, the scope of the invention should be limited only by the attached claims.

It should also be noted that the term “comprising” does not exclude other elements or steps and “a” or “an” does not exclude a plurality. On the other side, the term “comprising” may also include the case of “consisting of”. Also, elements described in association with different embodiments may be combined. It should also be noted that reference signs in the claims should not be construed as limiting elements.

We claim:

1. A method of managing a virtual image in a cloud environment by implementing a customizable virtual image deployment, the method comprising:
generating a virtual image and generating a set of configuration parameters related to specific parts of the virtual image;
assigning a set of values to the configuration parameters, and;
deploying the virtual image using the set of values assigned to the configuration parameters,
such that parts of the virtual image are deployed as a customized virtual image depending on the set of values of the configuration parameters.

2. The method according to claim 1, wherein the generating of the virtual image comprises defining points of variability of the virtual image.

3. The method according to claim 1, wherein the generating of the virtual image comprises to include an activation logic into the virtual image.

4. The method according to claim 1, wherein the activation logic is adapted to activate the parts of the virtual image depending on the points of variability and the set of values of the configuration parameters.

5. The method according to claim 1, wherein the generating of the configuration parameters comprises storing the configuration parameters together with the virtual image.

6. The method according to claim 1, wherein the generating of the virtual image and the set of configuration parameters is based on using a virtual image template developer.

7. The method according to claim 1, wherein the generating of the virtual image comprises a generation of the virtual image in a standardized format.

8. The method according to claim 1, wherein the deploying of the virtual image comprises a deploying in different topologies.

9. A virtual image managing system of managing a virtual image in a cloud environment by implementing a customizable virtual image deployment, the virtual image managing system comprising:
a first generation unit adapted to generate a virtual image, and a second generation unit adapted to generate a set of configuration parameters related to specific parts of the virtual image;
an assignment unit adapted to assign a set of values to the configuration parameters; and
a deployment unit adapted to deploy the virtual image using the set of values assigned to the configuration parameters,
such that parts of the virtual image are deployed as a customized virtual image depending on the set of values of the configuration parameters.

10. A computer system comprising the virtual image managing system according to claim 9.
